(19) United States
(12) Patent Application Publication
(10) Pub. No.: US 2016/0258904 A1
(43) Pub. Date: Sep. 8, 2016

(54) Process Control

(71) Applicant: BP Corporation North America Inc., Naperville, IL (US)

(72) Inventors: Margarit Lozev, Naperville, IL (US); Edo Becker, Hedon (GB); Steven Orwig, Geneva, IL (US); Claudio Avila, Hull (GB); Gordana Djordjevic, La Jolla, CA (US); Anthony Gachagan, Glasgow (GB); Craig Herdsman, Hull (GB); Anthony Mulholland, Glasgow (GB); Andrew Poole, South Cave (GB); George Vickers, Aurora, IL (US)

(73) Assignee: BP Corporation North America Inc., Naperville, IL (US)

(21) Appl. No.: 15/043,724

(22) Filed: Feb. 15, 2016

Related U.S. Application Data
(60) Provisional application No. 62/128,348, filed on Mar. 4, 2015.

(51) Int. Cl. G01N 29/02; G01N 29/26

(52) U.S. Cl. CPC G01N 29/02; G01N 29/262

(57) ABSTRACT

A method for controlling a process stream comprises detecting interfaces that are present in the process stream under a set of conditions using a phased array ultrasound probe, reconstructing an image of the interfaces, and providing the image, or information derived therefrom, to a control system. The control system either modifies or maintains the set of conditions in process stream. The method may be used for controlling an industrial process stream, such as a process stream in a chemical or petrochemical processing plant.

### FIELD OF THE INVENTION

The present invention relates to a method and system for controlling a process. In particular, the present invention relates to a method and system for controlling a process in which a phased array ultrasound probe is used to monitor the effect of process parameters on a process stream. The method and system may be used for controlling an industrial process stream, such as a process stream in a chemical or petrochemical processing plant.

### BACKGROUND OF THE INVENTION

Process streams in large scale industrial process often include particles, bubbles, droplets and phase boundaries. In the past, optical imaging, acoustic imaging, NMR techniques and X-ray imaging have all been used for analysing process streams.

Optical imaging involves the use of a camera to capture a two-dimensional image of a three-dimensional object using visible, ultraviolet or infrared light. An algorithm is used to transform a three-dimensional view of an object into a two-dimensional image, taking into account the perspective and some lens correction. The resulting images are subsequently analysed using image analysis methods to extract data.

There are a number of drawbacks associated with optical techniques. The data which is derived from an optical image includes inherent errors: those arising from assumptions in the transformation algorithm, as well as those caused by lens distortion. Moreover, a transparent window and a light source are required in order for an optical camera to be able to capture an image of a sample.

The use of optical imaging for measuring bubbles size distribution is disclosed in U.S. Pat. No. 5,152,175. According to the disclosure in this document, a bubble measurement cell has a transparent viewing chamber through which a photograph may be taken of the shadows of the bubbles. The photograph may then be subjected to photographic analysis to measure the size and the distribution of the bubbles.

Acoustic assessment has typically been carried out using single element transducers. The operational principle used for these methods is called insonification. This involves the emission from single element transducers of different ultrasound frequencies. When a frequency matches the harmonic frequency of a specific bubble size, the bubble vibrates generating its own frequencies at n times the original frequency. The harmonic frequencies emitted by the bubbles can be collected and related to the original size of the bubble (see, for example, the disclosure in U.S. Pat. No. 5,913,823).

An example of acoustic imaging using a single element transducer is disclosed in U.S. Pat. No. 6,408,679. According to the disclosure in this document, a low-frequency pump signal is used to excite bubbles so that they resonate at a frequency related to their diameter.

However, single element transducers are only able to sense objects in a line in front of the sensor, and many ultrasound frequencies may be needed to characterize a sample which contains a broad size distribution of bubbles. Since it is necessary to produce an excitation in the object to be detected, many objects in a sample may pass a single element transducer undetected.

To create an image of an area, a mechanical scanning device may be used with a single element transducer. However, with a fast flowing stream, the speed of the bubbles or particles in the stream may be significantly greater than the movement of the mechanical scanning device (e.g. 0.1 m/s). Accordingly, the mechanical scanning device may not be fast enough to identify the exact position and size of objects in the stream. Another method involves using several single element transducers to form an image.

In both cases, the images created are denominated amplitude mode (referred to as A-mode) images. These are the simplest type of ultrasound image. To generate A-mode images, one or more transducers work independently, scanning a line through the medium, with the ultrasound echoes plotted on a screen as a function of depth. In such methods, the ultrasound signals travel through the fluid independently of each other, and no type of constructive interference arises. The resolution of the produced images tends to be extremely poor due to the separation between adjacent transducers and the size of the one or more transducer elements (often bigger than 15 mm). Accordingly, the one or more transducers may detect ultrasound from an area which is larger than the objects to be detected, such as particles or bubbles.

In alternative acoustic imaging techniques, the attenuation of the backscattered signal may be measured. These sound attenuation techniques also use single element transducers and suffer from many of the drawbacks mentioned previously.

An example of such a process is disclosed in U.S. Pat. No. 7,114,375. According to the disclosure in this document, a fermentation process may be monitored by detecting ultrasound backscattered from the cells as a function of time. The backscattering measurements can be used to determine a growth phase transition, such as the transition between the logarithmic growth phase of the cells and their stationary phase.

Phased array ultrasound was developed first for medical diagnosis of animal tissues and bones, and later for non-destructive evaluation of materials, for instance to detect corrosion or assess welding in metals.

In a phased array ultrasound probe, a plurality of elements are used in sync. The elements are miniaturized piezoelectric transducers, typically mounted in a single rigid case. A short duration, high voltage pulse is applied to the elements which, in turn, creates a mechanical vibration or an acoustic wave. The elements may be pulsed individually or in groups. Accordingly, the elements can be synchronised to pulse as a group, and wavefronts may be directionally controlled by beam focusing and beam steering. How the elements are controlled is chosen to match the ultrasonic application requirements.

A phased array ultrasound probe is used in US 2008/015440. According to the process disclosed in this document, seeding tracers are added to a flow field and ultrasound is used to create ultrasound brightness mode (also known as B-mode) images from which velocity vectors of flow within the field may be determined. The process is used for characterizing the flow of mammalian blood in the body, and requires the introduction of external agents to generate a suitable contrast to extract useful information from the images.

There is a need for a non-invasive, high resolution method for monitoring industrial process streams which enables the process streams to be controlled in real-time.

### SUMMARY OF THE INVENTION

The present invention provides a method for controlling a process stream, said method comprising detecting interfaces that are present in the process stream under a set of conditions using a phased array ultrasound probe, reconstructing an image of the interfaces, and providing the image, or information derived therefrom, to a control system, wherein the control system either modifies or maintains the set of the conditions in process stream.

Also provided is a system comprising: a process stream under a set of conditions, a phased array ultrasound probe which detects interfaces that are present in the process stream, means associated with said phased array ultrasound probe for reconstructing an image of the interfaces, and a control system which, based on the image or information derived therefrom, either modifies or maintains the set of conditions in the process stream.

The use of a phased array ultrasound probe in a method for controlling a process stream is also provided.

### BRIEF DESCRIPTION OF THE DRAWINGS

FIGS. 1 and 2 depict a process stream which is being controlled according to a method of the present invention;

FIG. 3 depicts ultrasound images of a water vessel which is being stirred at agitation speeds of 50, 500, 1000 and 1500 RPM;

FIGS. 4a-c depict ultrasound images of gas bubbles in water over a large area and a small area, and a bubble diameter distribution graph;

FIGS. 5a-c depict an ultrasound image of an oil stream in water and ultrasound images of oil droplets in water reconstructed using two different algorithms as compared to optically obtained images;

FIG. 6 depicts ultrasound and optical images of the dissolution of NaCl grains in water that were obtained at the point at which the NaCl grains were added, 10 s after their addition and 40 s after their addition;

FIG. 7 depicts ultrasound images of biomass mixing with water at four different times: t1, t2, t3 and t4;

FIG. 8 depicts graphs showing size data obtained directly from ultrasound images of biomass being mixed with water at concentration of 5 g/L and at a speed of 500 RPM;

FIG. 9 depicts a sequence of ultrasound images obtained from a metal fuel tank filling process; and

FIG. 10 depicts a graph of gas volume fraction against time for a base fuel, a base fuel with a first additive, and a base fuel with a second additive in a metal fuel tank filling process.

### DETAILED DESCRIPTION OF THE INVENTION

A phased array ultrasound probe is a single probe which is made up of a plurality of elements. Each element forming the probe may act as an ultrasound sender and receiver. The elements in the probe are synchronized to either send or receive ultrasound signals.

Typically, the elements will operate in pulse-echo mode, whereby each of the elements sends an ultrasound signal before switching into ultrasound receiver mode. The switching between acting as an ultrasound sender and an ultrasound receiver is synchronized across the elements.

In use, the elements in the probe send ultrasound waves, such as beamformed ultrasound waves, into the process stream. These waves travel through the process stream, and interact with interfaces that are present, such as solid-liquid, liquid-liquid and gas-liquids interfaces. Some of the energy from the ultrasound waves reflects back from the interface through the process stream as an echo. Some of the energy will not be reflected, but will keep travelling through the process stream and potentially interact with further interfaces. Ultrasound echoes are detected by the elements when they are acting as receivers.

A phased array controller is used to synchronise the elements in a phased array ultrasound probe. The phased array controlled is an electronic instrument that controls the elements using electronic signals, such as time delayed electronic signals. This enables high speed and highly synchronized sending and receiving of ultrasound signals from the probe.

In some instances, a wedge will be used. A wedge is used to alter the angle at which the beam is transmitted into the process stream. When using a wedge, the delay laws must be adjusted to compensate for the additional propagation delay caused by the wedge. Delay laws are typically programmed to steer the sound beam above and below the nominal wedge angle to scan a range of angles. This technique improves ultrasonic coverage and increases the probability of detecting anomalies in the test area.

The elements in the phased array ultrasound probe are preferably miniaturised as compared to the elements that are typically used in single element ultrasound transducers. The dimensions of the elements may be optimized for a specific application via ultrasonic modeling and simulations, thereby enabling reliable performance of the probe.

The elements in the phased array ultrasound probe may have a width of less than 5 mm, such as less than 2 mm or less than 1 mm. Where the elements have a width of less than 1 mm, the pitch of the elements in the phased array ultrasound probe may be from 1 mm to 2 mm, such as 1.7 mm. The relatively small size of the elements enables the phased array ultrasound probe to produce high resolution images of a process stream. The width of the element is understood in the art to mean the distance from one side of the element face to the other, along the axis on which the elements lie. The pitch of the element is understood in the art to mean the center-to-center distance between two successive elements (i.e. the pitch is a parallel measurement to the width).

The phased array ultrasound probe may contain at least 4 elements, such as at least 8 elements or at least 16 elements. The number of elements is technically unlimited but, e.g. for industrial applications, will typically be less than 1024, and typically less than 256. The elements are generally each of the same size, though it is possible to use elements of different sizes in circumstances where different resolutions are required at different locations.

The phased array ultrasound probe may be an annular array probe (i.e. the elements are configured as a set of concentric rings, generally with each element having a consistent surface area and therefore a different width), a circular array probe (i.e. the elements on a cylinder, generally for tube inspection from the inside i.e. convex, but may also be for inspection from the outside i.e. concave), a curved array probe (i.e. a curved array probe designed typically for inspection from the inside of tubes i.e. convex, or from the outside of tubes i.e. concave), a daisy array probe (i.e. a linear array curved into a circle such that the ultrasound is emitted along the axis of the circle/cylinder), a linear array probe (i.e. a set of elements aligned along a linear axis), a matrix array probe (i.e. an active area divided in two dimensions using different elements, typically in a checkerboard format), a sectorial array probe (i.e. an annular array probe in which the annular rings are subdivided into multiple elements), or a sparse matrix array probe (i.e. a matrix array containing less than 100% elements such that effective gaps occur between elements). It will be appreciated that some probes may fall under the definition of more than one of the aforementioned types of probe.

Different types of probe may be preferable in different scenarios. For instance, a matrix scan may be more suitable than a linear scan where high accuracy in more than one plane are desired. A concave array probe may be preferred when a scan around the circumference of a vessel, e.g. a pipe, desired. For the purposes of the present invention, the phased array ultrasound probe is preferably a linear phased array probe or a matrix phased array probe, or variations thereof.

In some instances, it is desirable for each of the elements to lie within a single plane (i.e. the surface of the probe is not curved). In other instances, e.g. where the probe is used with a curved pipe, it is desirable for the surface of the probe to be curved.

The phased array ultrasound probe may be used to carry out electronic linear scans. In these instances, groups of elements emit an ultrasound signal in turn along the length of the phased array probe. Within each group of elements, each element is synchronized to emit ultrasound signals simultaneously.

In some instances, the phased array ultrasound probe may be used to carry out multiple linear scans in the form of a raster scan.

A mechanical linear scan may be used in addition to the electronic linear scan. In this instance, the phased array ultrasound probe is physically moved (typically at a speed of up to 6 m/s such as from 2 to 4 m/s), at the same time as the ultrasound signal is electronically moved. This allows a volume of fluid which is greater than the acoustic footprint of the probe to be included in the scan.

Electronic linear scans may be carried out with beamforming.

Beamforming may include beam focusing, i.e. the focusing of ultrasound energy in a specific region, increasing resolution in that region by increasing the active array aperture selected for the scan. The ultrasound beam may also be focused at a specific depth or multiple depths, using dynamic depth focusing (DDF). This improves the sizing performance of the probe.

Beamforming may alternatively include beam steering, i.e. the steering of the ultrasound energy, enabling the scanning of regions not directly in front of the probe thereby artificially increasing the field of view.

In some instances, beamforming involves beam focusing and beam steering.

The phased array ultrasound probe may use non-beamforming techniques to detect the interfaces that are present in the process stream. In these instances, each element is synchronized to fire at a different time. Non-beamforming scans include full matrix capture (FMC), sampling phased array (SPA) and volume focusing (VF) techniques. These techniques are commonly referred to as synthetic aperture techniques.

In the FMC technique, each element in the probe is successively used as the ultrasound signal transmitter, while all other elements are used as receivers for each ultrasound signal. This provides the maximum information from a single inspection location (i.e. from a single element), and allows a high resolution image of the process stream to be reconstructed.

In contrast to FMC, the SPA technique involves emitting an ultrasound signal from a single element, with all or a subset of the elements acting as receivers. It will be appreciated that FMC and SPA are opposite ends of the synthetic aperture spectrum in terms of the number of elements that are fired.

The VF technique occupies the middle ground between FMC and SPA. In this technique, the full array of elements in the probe emits ultrasound signals, with individual signals collected on groups of elements.

A mechanical linear scan may be used in addition to the non-beamforming techniques.

Many of these techniques may be carried out using the same probe, by simply using a different phased array algorithm A phased array algorithm is implemented by the phased array controller. Algorithms include delay law and focal law algorithms.

The phased array ultrasound probe may operate at a low power ultrasonic level. This is so that the ultrasonic energy that is sent into the process stream from the phase array probe does not cause any physical change to the process stream. The phased array ultrasound probe may operate at a frequency or frequencies in the range of from 0.1 to 40 MHz, such as from 0.5 to 20 MHz or from 1 to 10 MHz. These frequencies are useful in industrial applications.

The phased array ultrasound probes that are used in the present invention generate longitudinal ultrasound waves (also known as compressional waves). These waves can travel through solids and liquids but not typically through gases, such as air. This means that the probe works in condensed phases (i.e. solid and liquid phases), but not typically in the vapour phase (particularly in the abovementioned frequency ranges). The volume of the gas fraction may be worked out based on the reflections received from the gas-liquid or gas-solid interfaces, travelling back through to the phased array probe through the condensed phase (i.e. the solid or liquid phase).

The process stream preferably comprises a total amount of liquids which is greater, by volume, than each of the total amount of solids and the total amount of gases. For instance, the process stream preferably comprises greater than 50% by volume of liquid, more preferably greater than 75% by volume of liquid.

The phased array ultrasound probe detects interfaces that are present in a process stream. Accordingly, the process of the present invention may be used to detect particles (e.g. solid particles in a liquid stream), droplets (e.g. liquid particles in a liquid stream), bubbles (e.g. gas bubbles in a liquid stream) and phase boundaries (e.g. between a liquid and a gas, or between a liquid and a liquid). Of course, many of the different types of interface may be detected in a process stream, since process streams may contain particles, droplets, bubbles and multiple phases. As a consequence, the method of the present invention does not need an external agent to be added to the process stream to improve the contrast of the images.

The resolution of ultrasound images is related to a number of factors, including wavelength of the emitted ultrasound signals, as well as the velocity, temperature and density of the process stream with which the phased array ultrasound probe is used. Accordingly, the wavelength of the ultrasound signals emitted from the probe may be tailored according to the size of the objects to be detected in the stream. The phased array ultrasound probe is suitable for detecting particles, droplets and bubbles which are at least 0.3 mm in diameter, such as at least 0.7 mm in diameter.

The phased array ultrasound probe may be positioned on the outside or inside of the wall of a vessel through which the process stream runs, such as on the outside of a pipe.

Preferably, the phased array ultrasound probe is positioned outside of the wall of the vessel. For instance, the phased array probe may be positioned permanently on the outside of the wall of the vessel so as to allow continuous monitoring of the process stream. The phased array probe may also be incorporated into a mechanized scanner on the outside of the wall of the vessel. As mentioned above, this enables a larger area of the process stream to be monitored.

Since ultrasound signals can penetrate metal and plastic, there may be no need to drill holes or introduce cables into the vessel. This means that the method of the present invention can be carried out non-invasively and while the process is on-line.

Where the vessel walls interfere significantly with the ultrasound transmission, e.g. as may be encountered with some thick metal walls, then it may be necessary to modify the probe design to match the acoustic properties of the vessel walls and/or to use a delay line.

Where the phased array ultrasound probe is positioned inside of the wall of the vessel, it may, for instance, be immersed in the process stream directly, or mounted in a probe housing. The use of a probe housing helps to preserve the operational life of the probe. A probe housing will typically be cooled using air or water.

In some instances, e.g. those in which a linear probe is used, the orientation of the phased array ultrasound probe relative to the interfaces in the process stream (e.g. a phase boundary or direction of flow of bubbles, particles or droplets) is not crucial. Nevertheless, the orientation can be optimized in-situ by observing which orientation produces images of the best quality.

The process of the present invention may be carried out at a plurality of locations on a process stream. This may be achieved by using a phased array ultrasound probe at each of the plurality of locations on the process stream. This enables information on the process stream as a whole to be provided to the control system.

Reconstruction techniques are used to produce an image of the interfaces that are present in a cross-section or area of the process stream. Means for reconstructing an image of the interface include a computer. A reconstruction algorithm will typically be used. The Total Focusing Method (TFM) may be used to reconstruct the signals from the probe into an image. In some instances, the image that is produced is rectangular or square.

The computer for reconstructing an image of the interface may operate separately from the phased array controller, or it may be imbedded therein. The computer will include software, e.g. for implementing the reconstruction algorithm, and hardware for executing the software. The computer may contain interfaces for receiving, transmitting and/or otherwise communicating information e.g. in the form of data. The computer may contain memory elements to store information.

The area that is covered by the scan is variable, and may be selected by altering the settings of the phased array ultrasound probe. In some instances, axial and lateral distances are modified. The axial distance of the image (i.e. the image depth) depends on the speed of sound of the medium and the number of points sampled in the time domain. The lateral distance of the image depends on the size of the elements, the total number of elements forming the probe, and the active aperture selected for a linear scan.

For example, for a linear scan, an ultrasound signal may be sent sequentially from a specific sub-group of adjacent elements (also called the active aperture). The emitted ultrasound signal interacts with the measurable objects, producing reflections and scatterings which are received back in the same sub-group of adjacent elements operating as receivers. After each sequence of active elements is fired, the received signals may be combined producing a single ultrasonic time domain signal, forming a single line in the ordinate axis of the image. Sequentially, this process may be repeated across the whole probe, moving the position of the active elements one single step at a time, until reaching the last element of the probe (full linear scan producing a B-mode image).

The lateral size of the image is given by multiplying the size of a single element by the resulting number obtained from the total number probe elements minus the active aperture selected plus one. An example of this is provided in Table 1, for a probe consisting on 128 elements:

TABLE 1
Lateral field of view for different configurations of a 128 element linear scan

| | Configuration linear scan | | | | | | | |
|---|---|---|---|---|---|---|---|---|
| | 1:128 | 4:128 | 8:128 | 12:128 | 16:128 | 20:128 | 32:128 | 64:128 |
| Active aperture | 1 | 4 | 8 | 12 | 16 | 20 | 32 | 64 |
| Horizontal lines generated | 128 | 125 | 121 | 117 | 113 | 109 | 97 | 65 |
| Element size (mm) | 0.7 | 0.7 | 0.7 | 0.7 | 0.7 | 0.7 | 0.7 | 0.7 |
| Lateral field of view (mm) | 89.6 | 87.5 | 84.7 | 81.9 | 79.1 | 76.3 | 67.9 | 45.5 |

In some instances, the image that is reconstructed will be a two-dimensional image or a three-dimensional image. The images that are reconstructed are generally B-scan images, though C-, D- or S-scan images may also be produced.

Information about the process stream may be derived from the images. This information may be qualitative or quantitative.

Qualitative information may be derived from the images by a process operator. Qualitative information is information that is not quantitative in nature. For instance, qualitative information may relate to the formation of mixing or cavitation zones in the process stream, the general flow and location of bubbles, and any other non-numerical information on the process stream.

The frequency at which the images are provided to the control system may be greater than 1 image per second, for instance greater than 30 images per second or greater than 50 images per second. In general, a greater number of images may be produced per unit time where the area which is scanned is small and close to the phased array ultrasound probe. When the images are streamed to a control room, they form a video of the process stream. In this instance, the image that is reconstructed is considered to be a four-dimensional image.

In some instances, for instance where the area of the vessel that is scanned is relatively large and only qualitative information is needed, the frequency at which the images are captured may be lower. For instance, the images may be captured at a frequency of from 1 to 5 images per minute, such as from 1 to 10 images per minute.

Quantitative information includes data on geometric parameters of the process stream. Geometric parameters include location, cross-sectional area, diameter, circumference, volume, elongation, number and location of bubbles, droplets and particles, the location and thickness of phase boundaries, as well as the proportion of different phases in the process steam. Certain geometric parameters may not be measured directly from the images, but instead may be derived from those features which are measurable.

Geometric parameters may be derived from the image using image analysis algorithms. Software such as Labview and NI Vision plug-in may be used to program image analysis algorithms e.g. which may be used to obtain the size distribution of bubbles and particles in the stream in real-time. Machine-vision type of algorithms may also be used. Alternatively, image analysis algorithms can be programmed in MATLAB or C++ or any other programming language.

In some instances, the image analysis software calibrates the images. This enables the geometric parameters to be determined directly from the analysis of the images, irrespective of any change in conditions, such as temperature, pressure, mixing intensity, and process duration. Calibration may be carried out by using a reference object in the process stream. The reference object may be a static object (e.g. a point on the vessel wall) or a moving object with a known geometry. The calibration parameters may then be reset, without requiring the measurement of the sound speed.

A plurality of geometric parameters may be measured from a single image, more preferably simultaneously. For instance, the number of particles (or droplets or bubbles), and the diameter of the particles (or droplets or bubbles) may be measured from a single image.

Generally, the whole image will be analysed. In some instances, a region of interest in the image, for instance in the form of a magnified image, may be analysed.

The quantitative information may be prepared by combining data from a plurality of images. This will improve the degree to which the information is statistically representative. For instance, data on geometric parameters may be obtained from a plurality of images, and then at least one of an average (median), an average (mean) and a histogram may be calculated/produced for the geometric parameters. Quantitative information may be prepared by combining data from more than 5 images, such as more than 30 images, such as more than 50 images.

The frequency at which the quantitative information is provided to the control system will depend on a number of factors, for instance the time taken to acquire a single image of the system (which will, in turn, depend on the size of the area which is scanned), the time taken for data to be extracted from the image, and the number of images from which data is combined.

Information about the process stream (both qualitative and quantitative) is relayed to an operator.

In some instances, both quantitative and qualitative information will be relayed. For instance, qualitative information in the form of a video stream of images may be relayed to a control system together with quantitative information on the geometric parameters relating to the process stream.

The information is preferably provided to a control system in real-time. For instance, an image of the process stream, or information derived therefrom, may be provided to the control system within 10 seconds, such as within 5 second or within 1 second.

The control system may be operated by a human. A human is capable of using qualitative information to decide whether modifications should be made to the set of conditions in the process stream.

The control system may be operated by a computer. The computer may include software and hardware for executing the software. The computer may contain interfaces for receiving, transmitting and/or otherwise communicating information e.g. in the form of data. The computer may contain memory elements to store information.

In some instances, the computer will exercise automated control over the process stream. For instance, the computer may operate a distributed control system (DCS) for automated control.

In some instances, the control process is operated by both a human and a computer.

Based on the image, or information derived therefrom, the control system modifies or maintains the set of conditions in the process stream.

In instances where the process stream is shown to be as desired, no changes will be made to the conditions in the process stream.

In instances where the process stream is shown to be not as desired, the control system modifies the set of conditions in the process stream.

An actuator may be used to carry out modifications to the set of conditions in the process stream. The actuator may be a hydraulic, mechanic, electric, thermal, magnetic or pneumatic actuator. The actuator is controlled by the control system.

A wide range of modifications may be made to the set of conditions in the process stream. For instance, modifications may include modifying at least one of the operation of valves (e.g. mixing valves), operation of pumps (e.g. speed), degree of agitation (e.g. stirring speed), the flow rate (e.g. feed flow and/or the output flow), the temperature of the stream and the pressure in the stream. Modifications may also include changes to the level and volume of the process stream in the vessel through which it flows.

Modifications may also be made to the composition of process stream itself. For instance, modifications may include modifying the relative proportions of components in the process stream and, where a chemical reaction is taking place, modifying the reagents.

The method of the present invention is preferably an iterative process. In some instances, the method of the present invention is repeated at least 10 times, for instance at least 50 times, for instance at least 100 times.

An iterative method may be used to optimize a process stream. The process stream may be optimized by improvements in efficiency. Improvements in efficiency include increases in throughput, decreases in energy costs, and decreases in the cost of the apparatus.

The method may be used to monitor a process stream over a fairly short time period, such as a period of at least 10 minutes, such as a period of at least 20 minutes or a period of at least 30 minutes. In some instances, the method may be used to continuously monitor a process stream for a slightly longer time period, for instance for a period of at least 1 hour, such as a period of at least 12 hours or a period of at least 24 hours. In some instances, the method may be used to continuously monitor a process stream over a long period of time, such as for a period of at least 1 month, or even at least 1 year.

In some instances, the method may be used to continuously monitor a process stream. Alternatively, the method may be used to intermittently monitor a process stream.

The process stream may be present in any type of vessel. In some instances, the process stream may be held in the vessel. In these instances, the process stream may be being stirred, or the process stream may consist of multiple components which are being mixed. In other instances, the process stream may be flowing through a vessel such as a pipe.

The process stream is preferably an industrial process stream. The process stream may be found in a chemical or petrochemical processing plant. The process stream may be a chemical or petrochemical process stream. In some instances, the process stream may be a hydrocarbon process stream.

The process stream may form part of upstream processes, such as oil extraction or oil recovery processes. In these instances, the present invention may be used to control the sand or gas content of crude oil (e.g. during oil extraction or separation activities).

The process stream may form part of midstream processes, such as transportation processes. The process stream may be found in hydrocarbon transportation pipes.

The process stream may form part of downstream processes, such as refining and manufacturing processes.

Where the process stream is found in a refinery or a petrochemical plant, it may be found in an apparatus selected from: a desalter, a distillation apparatus, a chemical reactor, an aeration reactor, a fermentation reactor, transportation pipes, a fluidized bed reactor, a fluidised bed column, a crystalliser, a decanter, a scrubber column, a liquid-liquid column, an agitated reactor or vessel, and an aeration reactor for waste treatment. The apparatus may be operated in continuous mode, or in batch mode.

Where the process stream is found in a refinery or a petrochemical plant, the process of the present invention may be used to control: changes in gas bubble size distribution (e.g. in a water treatment plant); solid dilution and solid distribution (e.g. in liquid reactors); scrubber reactor for mass transfer optimization (e.g. in desalting of crude oil); reactor performance (e.g. by visualizing working conditions of mechanical parts as agitators and heat exchangers inside reactors, or by visualizing density gradients and operational conditions such as hot-spots, dead zones and cavitation areas inside reactors); fluid level (e.g. in distillation towers trays); iron sulfide corrosion (e.g. in naphthenic acid and sulfidation damage process mechanisms); air bubble size distribution (e.g. in a purified terephtalic acid reactor); CO dissolution (e.g. in acetyl reactors for optimizing CO utilization in the production of acetic acid or acetic anhydride); dead zones in reactors; and undiluted solids particles and unwanted contaminants in hydrocarbon streams.

Downstream manufacturing activities include lubricant processing, polymer processing and biofuel processing. Accordingly, the process stream may be found in a lubricant processing plant, a polymer processing plant or a biofuel processing plant.

Where the process stream is found in lubricant processing, the present invention may be used to control solids and gel additives dilution in reactors (e.g. during lubricant oil manufacturing).

Where the process stream is found in polymer processing, the present invention may be used to control the gas bubble size (e.g. during the manufacturing of polymers).

Where the process stream is found in biofuel processing, the present invention may be used to control: the CO₂ concentration in an aqueous media (e.g to optimize ethanol production); CH₄ bubbles size (e.g. for optimization of biochemical reactors during syngas fermentation); and droplet size in the liquid-liquid extraction (e.g solvent separation from alcohol mixture during continuous alcohol production by fermentation).

Though the process stream preferably forms part of a chemical or petrochemical industrial process, it will be appreciated that the method of the present invention may be used with a wide range of industrial streams. As an example, the process stream may be found in mining activities, such as mining ore extraction and recovery systems. In these instances, the present invention may be used to control air bubble size in flotation processes during extraction and recovery of mining ores.

The invention will now be described with reference to the accompanying figures and examples.

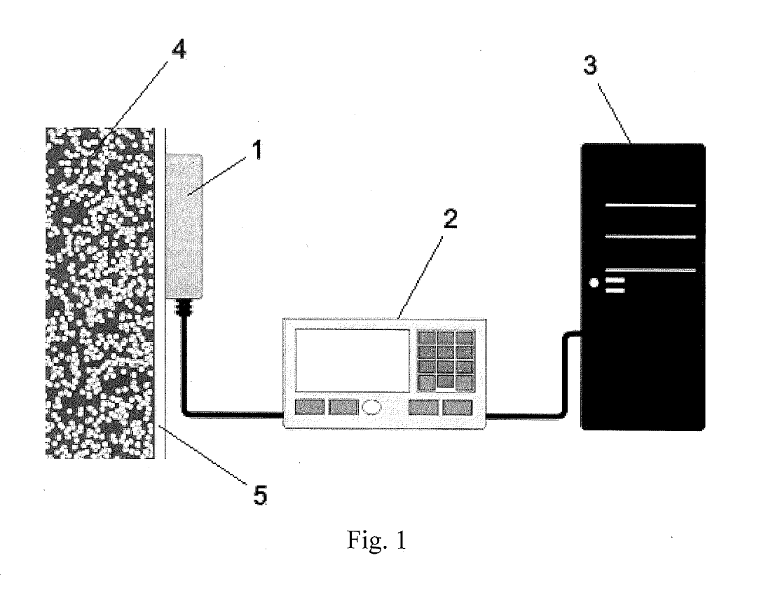

FIG. 1 shows a process stream (4) comprising a mixture of particles and liquid flowing through a pipe (5). A phased array ultrasound probe (1) is associated with the outside wall of the pipe (5). A phased array probe (1) attaching mechanism is not shown in FIG. 1, but may be used to attach the phased array probe (1) to the outside wall of the pipe (5).

In the system shown in FIG. 1, the phased array probe (1) is positioned parallel to the flow of the process stream (4). An electronic linear scan, with focusing and steering, is carried out on the process stream (4) in front the phased array probe (1). The process is controlled by a phased array controller unit (2). The results of the scan are passed back to the phased array controller unit (2) and on to a processing computer (3) where an image of the process stream is reconstructed.

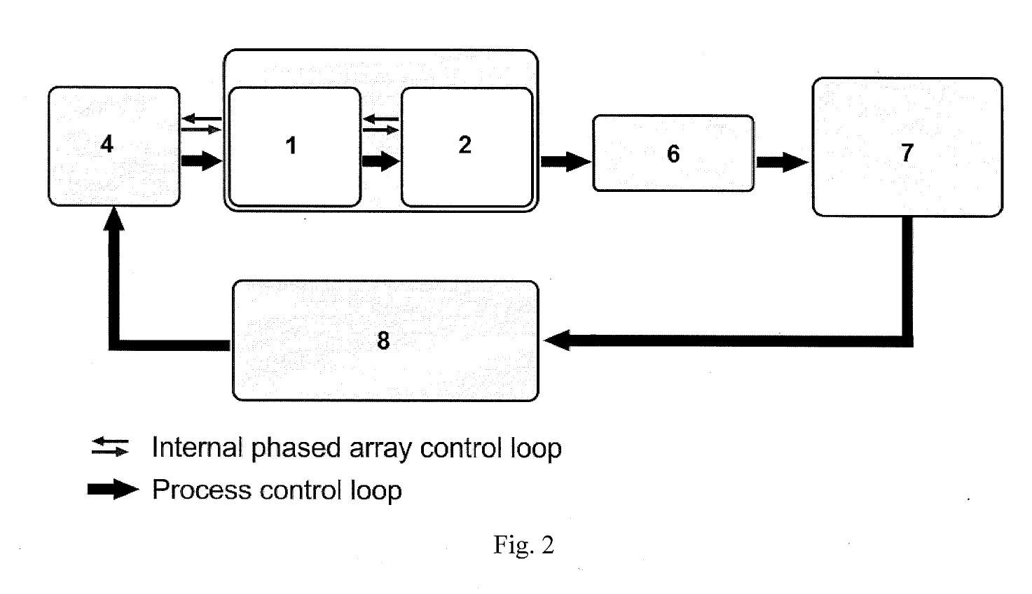

FIG. 2 shows that the image(s) obtained using the phased array probe (1), or information derived therefrom, may be passed to a control system (7) via a transmitter (6). The control system (7) may be operated by a computer, for instance according to a distributed control system, or by a human. The control system may modify the set of conditions in the process stream (4) using the actuator (8).

### EXAMPLES

### Example 1

### Control of Cavitation and Mixing Performance During Stirred Reactor Operation

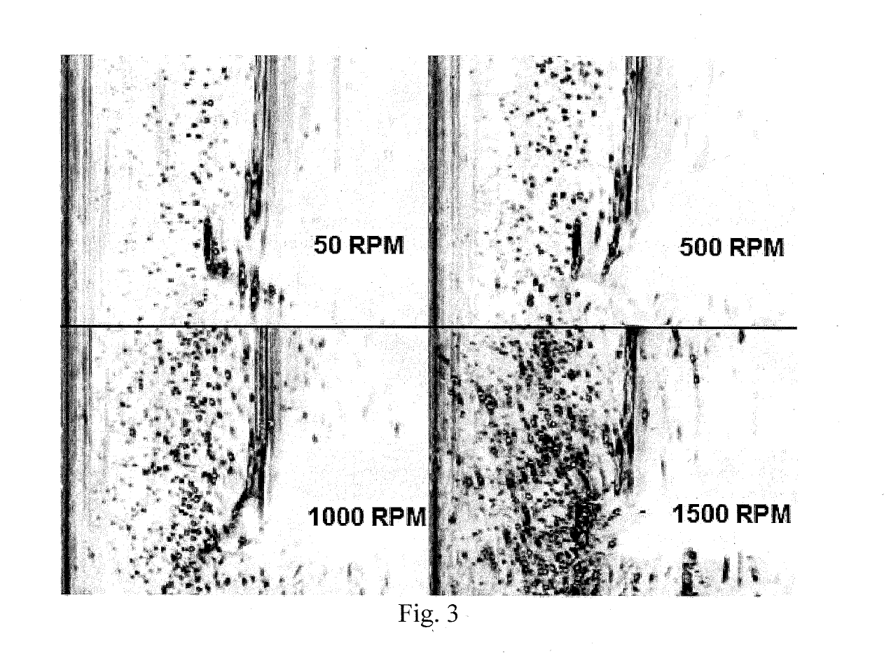

A 5 L tank was filled with water and stirred at different agitation speeds. A phased array ultrasound probe was permanently installed on the outside wall of the tank. The phased array probe was used to scan the tank. Images of water in the tank were captured in real-time and are shown in FIG. 3.

The images provide qualitative information which may be used to optimize the operation of the process. For instance, mixing or cavitation zones may be identified. Quantitative information may also be derived from these images and may be used to optimize the operation of the process. For instance, the size of the bubbles produced by the mechanical propeller or cavitation device can be directly determined. From the images, parameters such as the amount of energy needed to reach a desired mixing level or even the cavitation stage can be estimated.

The information that was derived from the images could be fed to a distributed control system at a fast speed, and corrective actions applied to the process in real-time.

It can be seen that the process of the present invention may be used for optimizing systems, for instance for optimizing the energy cost of a system.

### Example 2

### Control of Gas Bubble Size Distribution in a Liquid Reactor

Laboratory experiments were carried out to determine whether size control of gas bubbles in liquids is feasible by using phased array ultrasound to monitor a process stream.

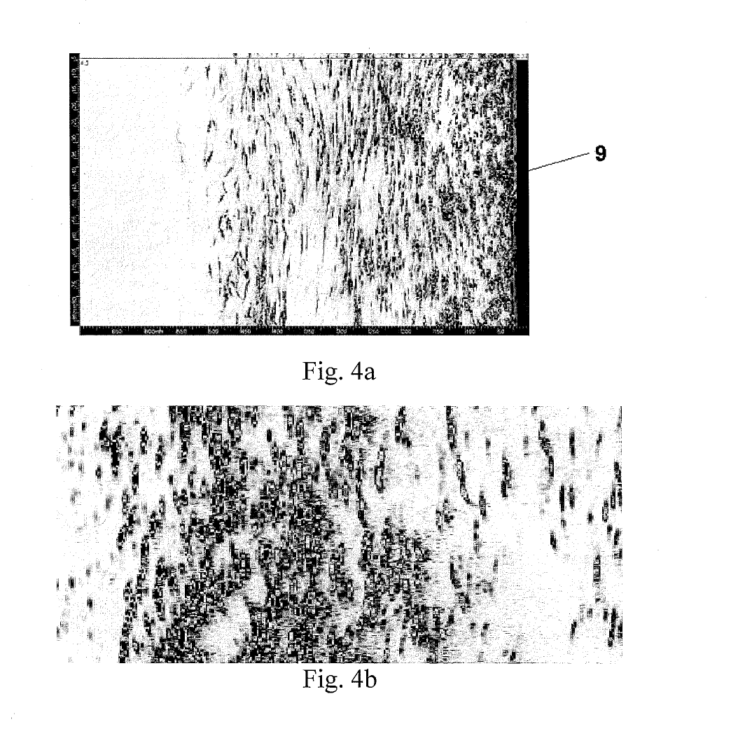

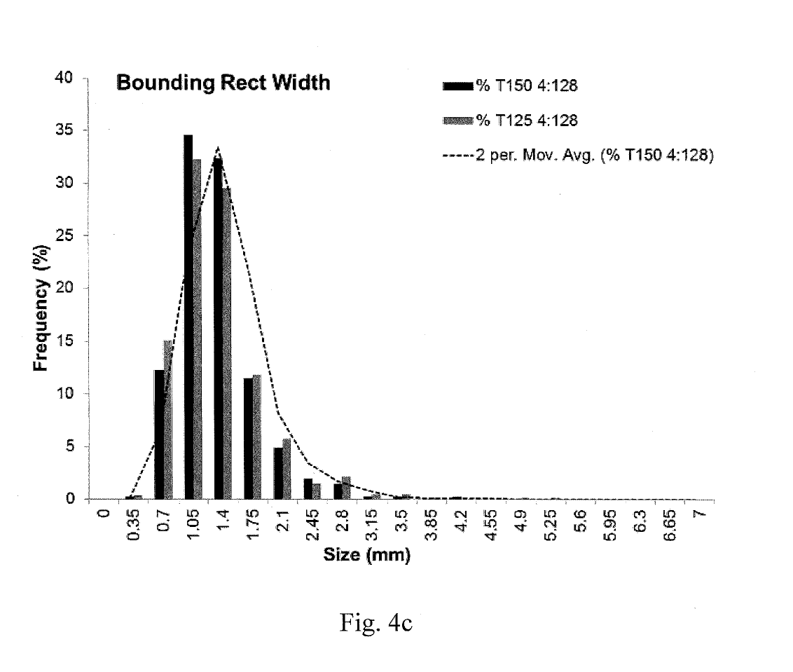

A tank was filled with water, and bubbles were passed through the tank. A phased array ultrasound probe (9 in FIG. 4a) was permanently positioned on the outside of the tank wall.

FIGS. 4a and 4b show images that were obtained using the phased array probe. Using delay laws, the phased array probe was set to scan the area extending up to 20 cm from the probe for the image shown in FIG. 4a. Qualitative information was derived from the images, such as the characteristic flow lines created by bubbles.

For the image shown in FIG. 4b, delay laws were set so that the phased array probe electronically scanned a much smaller area. Quantitative information was derived from this image using Labview and the NI vision plug-in. Using this software and the phased array probe, 10 images were obtained and analysed—containing approximately 1000 bubbles in total—within 1 second. A bubble diameter distribution graph is shown in FIG. 4c.

The data was validated by taking similar measurements from optical images.

This is further evidence to show that phased array probes may be used to monitor a system.

### Example 3

### Control of Oil Droplet Size in Water

An experiment was conducted to investigate whether the size of liquid droplets in a liquid medium could be controlled.

Water was filled in the bottom of a tank, and oil was filled on top. An immersed pump was fitted at the bottom of the tank, and was used to draw oil from the top of the vessel. A stream of oil droplets in the water was generated by introducing oil at the bottom of the vessel using a diffuser. A 128 element phased array ultrasound probe was positioned on the tank wall in a vertical position, i.e. in parallel to the droplet stream. The phased array probe was operated at a frequency of 5 MHz.

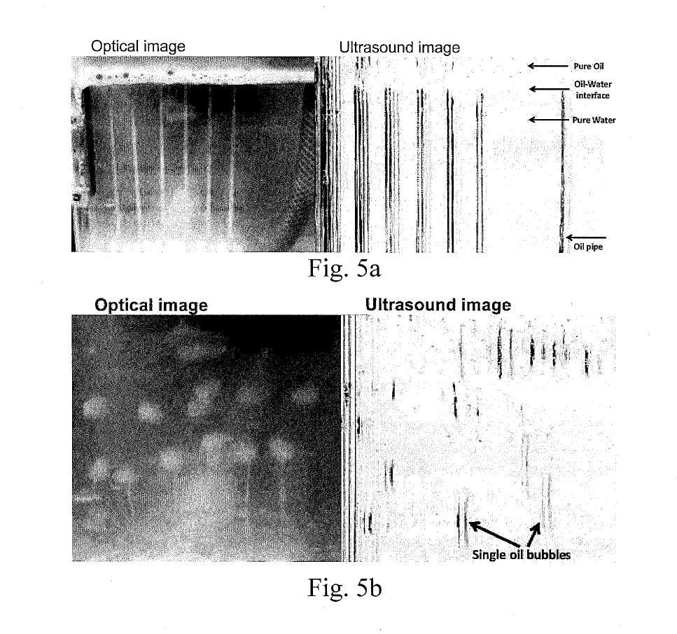

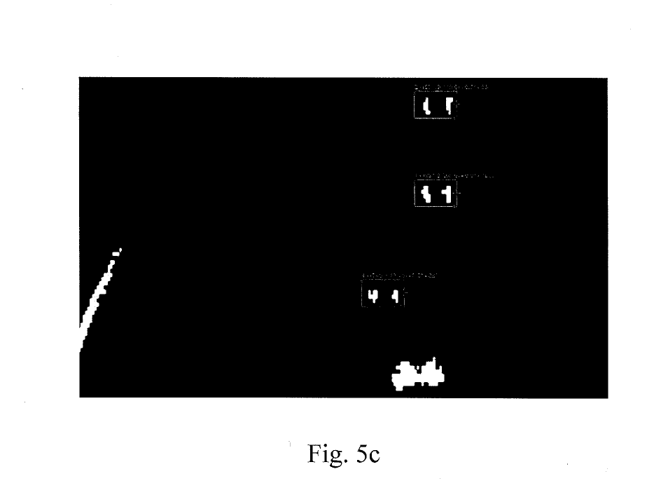

Initially, constant flow lines were generated in water. FIG. 5a compares an optical image of the oil flow with an ultrasound image. As can be seen from this image, water-oil interfaces produce reflections of the ultrasonic waves, which are received back at the same ultrasonic probe. Each oil stream appears as two parallel lines, and the distance between these lines corresponds to the width of the oil stream. Part of the transmitted signal passed across the water-oil interface producing a reverberation of the wave inside the oil, generating back reflections—these can be seen as a lower intensity double line beside the stronger lines. The latter can be used for checking the width measurements, or they can simply be deleted from the image.

Oil droplets in water were then generated. FIG. 5b compares an optical image of the oil droplets with an ultrasound image. As with the oil stream, the oil droplets appear as two parallel lines moving across the field, and the distance between these lines corresponds to the oil droplet diameter. From the quantitative information on the droplet diameter, other geometric parameters were estimated such as the surface area and perimeter of the droplets.

A machine-vision processing algorithm was also used to reconstruct an image from the signals sent by the phased array probe. This image is shown in FIG. 5c. The position and the diameter of the droplets were measured from the image. As with the image shown in FIG. 5b, the distance between the parallel marks correspond to the oil droplet diameter.

### Example 4

### Control of Solid Dilution (NaCl in Water)

Experiments were carried out to investigate the dissolution of solids in a liquid.

A plastic jar was filled with purified water. The jar was then submerged in a larger vessel filled with water. The ultrasound probe was positioned on the outside of the vessel. Grains of NaCl were slowly added to the plastic jar.

The system was scanned and images were relayed to the control system at a frequency of 10 frames per second in the form of a video. In this case, the ultrasound reflections are due to both solid NaCl grains and microbubbles in the system.

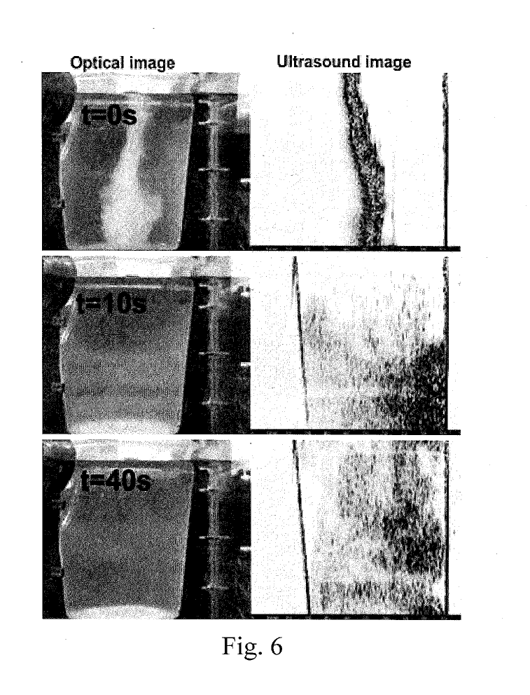

FIG. 6 compares optical images with ultrasound images at various points after the addition of the NaCl grains. From this, it can be seen that the activity produced by the dissolution of the NaCl is observable from the ultrasound images for far longer than from the optical images.

Information provided by, or derived from, these ultrasound images may be used to optimize the dissolution process. For instance, the images may be used to determine the optimum use of additives (e.g. amount of solvent and solutes required), as well as for identifying efficient mixing techniques.

A similar experiment was conducted, but with much larger grains of NaCl added to the system. Activity in the system was detected by a phased array ultrasound probe for up to 5 hours after addition of the salt.

### Example 5

### Control of Biomass Particle Size and Mixing Behavior in Water

A further experiment was carried out to investigate the use of a phased array ultrasound probe in controlling solid particle size and mixing in a liquid.

A tank was filled with water. Sawdust particles (biomass) of three particle size ranges (0.2-0.5 mm, 0.5-1.0 mm, 1.0-2.0 mm) were added to the tank at a concentration of 5, 10 and 50 grams per liter of water. The tank was stirred at 500 RPM from which ultrasound images were continuously obtained.

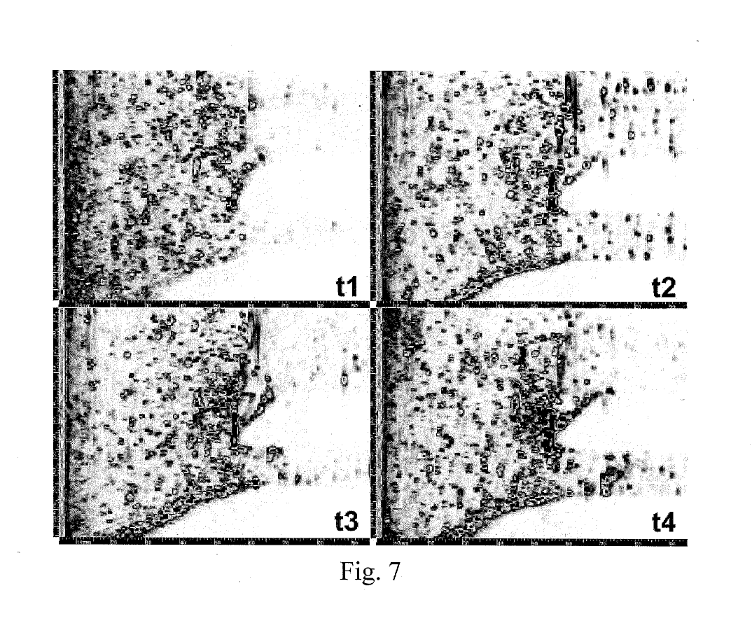

FIG. 7 shows images of the system over time, from which qualitative information was derived such as preferential deposition areas and the flow patterns.

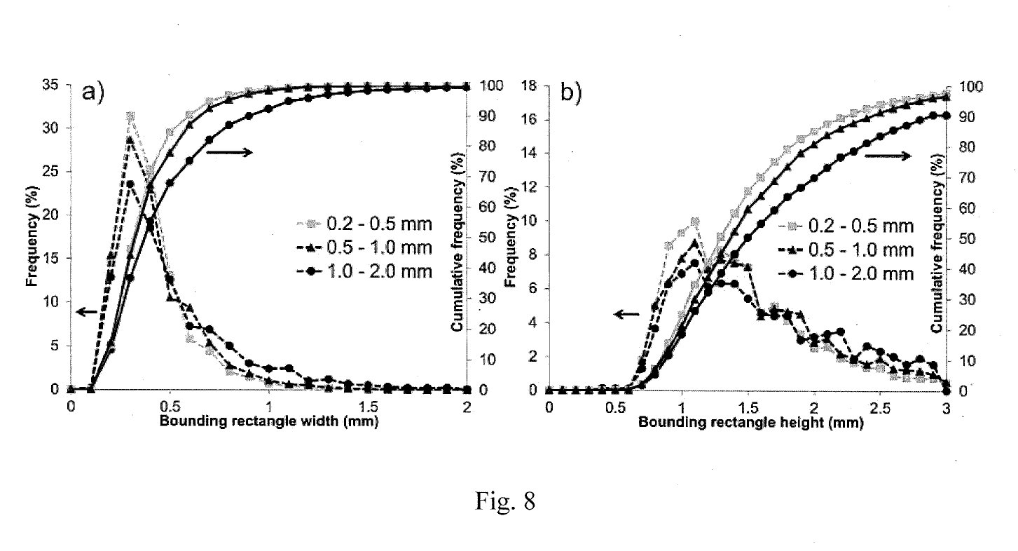

At the lower concentrations (5 and 10 g/L), the particles could be individually identified from images, and quantitative measurements obtained. The diameter, area, perimeter, particle shape and morphology were directly measured. FIG. 8 show size data obtained directly from the ultrasound images by applying an image analysis method.

At the higher concentrations (above 12 g/L), or when the mixing speed was very high with the lower concentrations, the sawdust particles attenuated the ultrasound waves reducing the penetration of the beam in the vessel, though information—particularly qualitative information—could still be derived.

### Example 6

### Control of Volume Fraction During Fuel Tank Filling

A 200 L metal fuel tank was filled with diesel fuel at high speed. A large number of air bubbles were generated and a foam formed on top of the fuel. The formation of foam in this way is a problem, since it considerably reduces the useful tank volume. The foam formation is directly related to the bubble behaviour during the filling process. By controlling the bubble development during the process this problem can be minimized.

A phased array ultrasound probe was attached to the outside of the metal wall of the fuel tank.

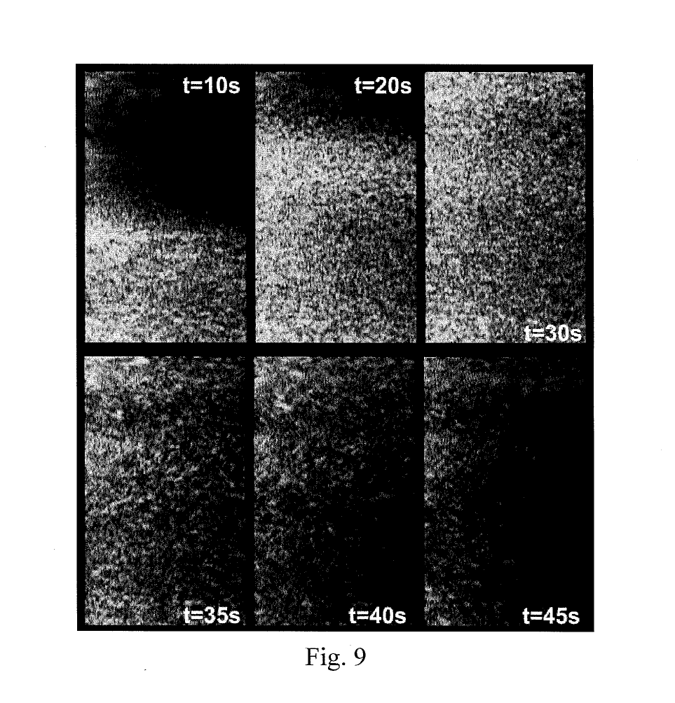

The phased array probe was positioned outside the fuel tank in vertical position, and was used to non-invasively measure the air volume fraction in the tank during a tank filling operation. Images were produced at a frequency of 5 frames per second. The full tank filling process took approximately 60 seconds for each run. FIG. 9 shows a sequence of ultrasound images obtained from this process.

The volume fraction was derived from the ultrasound images using a simple image analysis method. This information was obtained for each image frame and plotted in graph form against time.

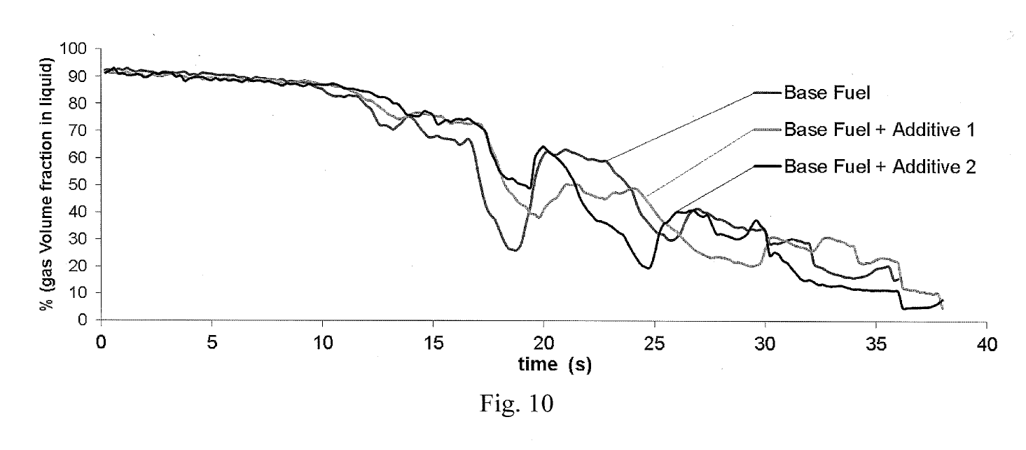

FIG. 10 depicts a graph of gas volume fraction against time for a base fuel, a base fuel with a first additive, and a base fuel with a second additive, obtained from image analysis. Air bubble decay can be seen for each fuel type.

Control measures were applied to reduce the amount of air bubbles generated by changing the composition and quantities of the fuel additives used.

What is claimed is:

1. A method for controlling a process stream, said method comprising detecting interfaces that are present in the process stream under a set of conditions using a phased array ultrasound probe, reconstructing an image of the interfaces, and providing the image, or information derived therefrom, to a control system, wherein the control system either modifies or maintains the set of conditions in process stream.

2. The method of claim 1, wherein said image, or information derived therefrom, is provided to the control system in real-time.

3. The method of claim 1, wherein the phased array ultrasound probe is selected from annular array probes, circular array probes, convex array probes, concave array probes, daisy array probes, linear array probes, matrix array probes, sectorial array probes and sparse matrix array probes.

4. The method of claim 1, wherein the phased array ultrasound probe detects the interfaces that are present in the process stream using an electronic linear scan.

5. The method of claim 4, wherein a beamforming technique is used in detecting interfaces that are present in the process stream.

6. The method of claim 5, wherein the beamforming technique is beam steering, beam focusing, or both beam steering and beam focusing.

7. The method of claim 5, wherein the phased array ultrasound probe detects the interfaces that are present in the process stream using a raster scan.

8. The method of claim 1, wherein the phased array ultrasound probe detects the interfaces that are present in the process stream using a non-beamforming technique.

9. The method of claim 8, wherein the non-beamforming technique is selected from full matrix capture (FMC), sampling phased array (SPA) and volume focusing (VF) techniques.

10. The method of claim 1, wherein the phased array ultrasound probe detects the interfaces that are present in the process stream using a mechanical scan.

11. The method of claim 1, wherein the phased array ultrasound probe operates at a frequency or frequencies in the range of from 0.1 to 40 MHz.

12. The method of claim 1, wherein the method comprises detecting at least one of particles, droplets, bubbles and phase boundaries in a process stream.

13. The method of claim 1, wherein the phased array ultrasound probe is located on the outside of a wall of a vessel through which the process stream runs.

14. The method of claim 1, wherein the method is carried out at a plurality of locations on a process stream.

15. The method of claim 1, wherein qualitative information in the form of an image is provided to the control system.

16. The method of claim 15, wherein the control system is provided with images at a frequency of greater than 1 image per second.

17. The method of claim 1, wherein the information that is derived from the image is quantitative information.

18. The method claim 17, wherein the quantitative information includes data on geometric parameters of the process stream.

19. The method of claim 18, wherein the quantitative information is prepared by combining data on geometric parameters of the process stream from more than 5 images.

20. The method of claim 17, wherein qualitative information in the form of a video stream of images and quantitative information on geometric parameters of the process stream are relayed to the control system.

21. The method of claim 1, wherein the control system is operated by a human or by a computer.

22. The method of claim 21, wherein the computer exercises automated control over the process stream.

23. The method of claim 1, wherein the control system modifies the set of conditions in the process stream.

24. The method of claim 1, wherein the process stream forms part of a chemical or petrochemical processing plant.

25. The method of claim 24, wherein the process stream is found in upstream processes such as oil extraction and recovery, midstream processes such as transportation, or downstream processes such as refining and manufacturing.

26. A system comprising:
a process stream under a set of conditions,
a phased array ultrasound probe which detects interfaces that are present in the process stream,
means associated with said phased array ultrasound probe for reconstructing an image of the interfaces, and
a control system which, based on the image or information derived therefrom, either modifies or maintains the set of conditions in the process stream.
